(19) United States
(12) Patent Application Publication
(10) Pub. No.: US 2011/0047618 A1
(43) Pub. Date: Feb. 24, 2011

(54) Method, System, and Computer Program Product for Malware Detection, Analysis, and Response

(75) Inventors: David E. Evans, Charlottesville, VA (US); Adrienne P. Felt, Charlottesville, VA (US); Nathanael R. Paul, Greenville, SC (US); Sudhanva Gurumurthi, Charlottesville, VA (US)

Correspondence Address: UNIVERSITY OF VIRGINIA PATENT FOUNDATION, 250 WEST MAIN STREET, SUITE 300, CHARLOTTESVILLE, VA, 22902, US

(73) Assignee: UNIVERSITY OF VIRGINIA PATENT FOUNDATION, Charlottesville, VA (US)

(21) Appl. No.: 12/445,889

(22) PCT Filed: Oct. 18, 2007
(86) PCT No.: PCT/US07/22229

§ 371 Date: Aug. 11, 2009

Related U.S. Application Data
(60) Provisional application No. 60/852,609, filed on Oct. 18, 2006.
(60) Provisional application No. 60/993,766, filed on Sep. 14, 2007.

(51) Int. Cl. G06F 11/00

(52) U.S. Cl. 726/23

(57) ABSTRACT

A method, system, and computer program product for detecting malware from outside the host operating system using a disk, virtual machine, or combination of the two. The method, system, and computer program product detects malware at the disk level while computer files in the host operating system are in actual program execution by identifying characteristic malware properties and behaviors associated with the disk requests made. The malware properties and behaviors are identified by using rules that can reliably detect file-infecting viruses. The method, system, and computer program product also uses the disk processor to provide accelerated scanning of virus signatures, which substantially decreases overhead incurred on the host operating system by existing malware detection techniques. In the event that malware is detected, the method, system, and computer program product can respond by limiting the negative effects caused by the malware and help the system recover to its normal state.

### RELATED APPLICATIONS

The present invention claims priority from U.S. Provisional Application Ser. No. 60/852,609, filed Oct. 18, 2006, entitled “Method, System, and Computer Program Product for Behavioral Malware Detection, Analysis, and Response,” and U.S. Provisional Application Ser. No. 60/993,766, filed Sep. 14, 2007, entitled “Method, System, and Computer Program Product for Behavioral Malware Detection, Analysis, and Response,” of which are hereby incorporated by reference herein in their entirety.

### GOVERNMENT SUPPORT

Work described herein was supported by Federal Grant Number NSF Grant Nos. CCR-0092945, 0627527, 0524432 and EIA-0205327, awarded by the National Science Foundation (NSF). The United States Government has certain rights in this invention.

### FIELD OF THE INVENTION

The invention relates to the field of malware detection. More specifically, the invention relates to identifying behaviors associated with malware, including, but not limited to, behaviors associated with viruses, worms, spyware, adware, Trojans, and rootkits.

### BACKGROUND OF THE INVENTION

Malware is found in a variety of forms, with each form being represented by a unique signature. The prior art shows malware detectors storing a library of signatures that are similar to known malware signatures. These malware detectors use this library of signatures to scan computer files for malware signatures, thus detecting malware. Much of this malware detection is carried out on the host operating system (OS).

The prior art also shows that this signature scanning method of malware detection can occur outside of the host operating system on a virtual machine. In this situation, a computer runs or tests a program file on the virtual machine before the file is actually executed by the host operating system. But the prior art does not teach any method, system, or program that analyzes the program file for malware from a point outside the host while that file is actually being executed on the host operating system.

The prior art also teaches methods of monitoring the reads and writes sent between the host operating system and the computer disk during actual program execution. But this monitoring is performed in order to increase efficiency in computer communications. The prior art fails to suggest that one analyze these reads and writes at the disk level using the disk processor during actual program execution with the purpose of detecting malware.

Additionally, the prior art discloses specialized external coprocessors used for malware detection. These devices, however, do not detect viruses using behavioral rules using the disk processor.

The adversarial relationship between malware creators and the malware preventors creates a competitive arms race between these two bodies. The malware creators constantly create new malware signatures and variations of those signatures, and the malware preventors, upon identifying those signatures and variations, add them to the signature library used in scanning. As these libraries continually grow, the malware detection programs designed to scan computer files using these libraries become more complex. The disadvantage of complex malware detection programs (i.e. programs with high overhead) is that they slow the host operating system by consuming processing resources.

### SUMMARY OF THE INVENTION

Aspects of various embodiments of the present invention are a computer method, system, and program product for detecting malware from outside the host operating system. Furthermore, the malware detection procedures are performed on the computer program files themselves while those program files are actually being executed on the host operating system.

The malware detection procedures claimed may be implemented either on a disk, virtual machine, or a combination thereof. This implementation structure allows the invention to operate at the disk level, which is the lowest layer in a computer system. The malware detection techniques taught in the prior art occur at higher layers in the computer system, not at the disk level. Because the invention operates at the disk level, it has the ability to observe general behaviors associated with malware, not simply scan for matches of malware signatures.

Generally, aspects associated with various embodiments of the present invention addresses challenges and issues for malware detectors, such as but not limited thereto, the following: ability to detect a large number of known viruses and an unlimited number of possible variants; ability to have false positive rates very close to zero (a false positive occurs when a malware detector misrecognizes a benign program as malicious) or as desired or required; and/or capability to not be so complex that it burdens and slows the host operating system, of which may be accomplished, for example, by providing the present malware detector system and related method operable with minimal performance overhead.

An aspect of an embodiment provides the ability of the invention to observe general malware behavior at the disk level through a multi-step procedure. First, the invention intercepts the read and write requests sent to the disk by the host operating system. Using the information in these requests, the invention performs an analysis that involves inferring the corresponding file system actions and identifying malware behaviors. This analysis is executed through the application of predetermined screening rules. These rules, among other things, detect infections of Windows executable files based on the known structure of executable files and the steps needed to successfully infect an executable file, detect suspicious modifications to core system files and other critical files, and recognize behavior of known malicious programs based on their disk access patterns.

An aspect of an embodiment of the invention provides a variety of response mechanisms for situations when malware behavior is detected, including, but not limited to, preventing the malicious disk requests from continuing on to infect the operating system and notifying the user and/or the host operating system that malware has been detected.

An aspect of an embodiment of the present invention provides using a computer disk to accelerate static signature scanning techniques. Algorithms, such as RE-trees, can be used in this process as a filtering device.

An advantage associated with various embodiments when compared to a higher layer signature scan, for example, includes performing the malware detection analysis at the disk level. This disk level approach allows for the identification of difficult malware instances and variants that traditional signature scanning malware techniques would likely miss. This is because difficult to detect malware can be identified with simpler and more basic rules and signatures at the disk level than at the operating system level. Also, a disk level malware detection technique would be more difficult for a malware designer to circumvent as compared to current techniques because disk level operations are less accessible and tougher to interpret for human users than host operating system operations.

Another advantage associated with various embodiments includes detecting malware through use of a system other than the host operating system. First, the negative effects caused by malware can be identified and addressed through a mechanism completely isolated from the host operating system. Second, malware definitions in the disk will be scanned even if the host system is compromised. Also, the host operating system is less burdened by the resources it takes to scan for malware, since the disk and/or virtual machine now performs some of these functions. This frees up the host machine to perform other useful work.

An additional advantage of an embodiment of the present invention is that it increases the data scanning rate of known static signature scanning methods. Also, the disk processor in computers is often underutilized, so the malware computations can be performed in isolation on the disk processor at almost not cost. A virtual machine malware detector can scan for malware while remaining isolated yet at a location where more information like memory and network accesses can be used.

Various embodiments of the present invention method, system, and computer program product code may cover multiple novel disk-level malware detection and response aspects that may include, but not limited thereto: detecting malware in a virtual machine that is isolated from the guest OS using signatures and policies; distributing malware analysis workload between the disk and host to reduce overhead; applying the use of a data structure as a new type of detector that can quickly check for membership in a set of regular expressions; designing and implementing low-level signatures to catch viruses using their I/O behavior; describing these low-level signatures with a newly designed specification language; catching viruses that may not be caught by other techniques or doing so in a much more efficient method (e.g. as opposed to polymorphic/metamorphic viruses with emulation); and providing better response mechanisms with the disk to recover from compromises.

For instance, an embodiment of the present invention VM-level detection technique may be implemented in actual program execution outside of the guest OS inside the virtual environment. This allows the present invention method, system, and computer program product code to detect malware by examining any state of the guest OS while remaining isolated. This design is beneficial for, but not limited thereto, detecting many types of malware and related threats. The various embodiments of the present VM-design may be a preliminary step in cases like legacy systems that may not use a disk with more semantic information.

The possibility of using both the VM and disk to detect malware is applicable. For example, a Guest OS is the monitored OS (e.g., Windows XP or other required or desired OS) running inside a virtual machine. The virtual machine may be provided to detect malware by looking at the Guest OS memory, network traffic, and other observable behavior. Finally, the disk is provided to analyze the I/O for malicious I/O behavior using a modified detector and the signatures.

Aspects of the present invention method, system, and computer program product code invention may be used to, among other things, better protect users from malware. This may be accomplished by for example, but not limited thereto, the decreased amount of resources required from the host to scan for malware using the disk, the reliable identification of malware at the disk-level by software that is not easily circumvented or subverted, a method to recover from a compromised machine via an isolated mechanism like the disk, and a method of malware detection outside of the host OS that can still observe higher-level actions like memory accesses and network activity. Implementing various aspects of the present invention means home machines or other applicable machines (as desired or required) could potentially stay malware free, and servers could avoid becoming compromised through running the invention's algorithms on the server's storage systems.

A goal of various embodiments of the present method, system, and computer program product is to speedup and improve the accuracy of virus detection to the extent that specialized external coprocessors are not required. Furthermore, various embodiments of present method, system, and computer program product may be focused on improving detection precision, not only on improving performance of existing detectors.

An aspect of various embodiments of the present invention computerized method comprises a method for detecting malware by observing behavior of a computer system in actual program execution from outside of a host operating system. The observing of the behavior may comprise: intercepting requests that are destined for computer disk; and inferring corresponding file system actions. The intercepting disk requests may comprise viewing the read and write operations sent from the host to the disk. The inferring file system actions may comprise analyzing the intercepted disk requests to identify malware behaviors. The analyzing may comprise applying predetermined screening rules.

An aspect of various embodiments of the present invention system comprises a computerized detection system or means for detecting malware. The computerized detection system or means is adapted to observe behavior of a host computer system in actual program execution from outside of a host operating system of the host computer system. The observing of the behavior may comprise: intercepting requests that are destined for computer disk; and inferring corresponding file system actions. The intercepting disk requests may comprise viewing the read and write operations sent from the host to the disk. The inferring file system actions may comprise analyzing said intercepted disk requests to identify malware behaviors. The analyzing comprises applying predetermined screening rules.

An aspect of various embodiments of the present invention provides a computer program product comprising a computer useable medium having a computer program logic for enabling one processor to detect malware. The computer program logic may comprise observing behavior of a computer system in actual program execution from outside of a host operating system. The observing of the behavior may comprise intercepting requests that are destined for computer disk; and inferring corresponding file system actions. The intercepting disk requests may comprise viewing the read and write operations sent from the host to the disk. The inferring file system actions may comprise analyzing said intercepted disk requests to identify malware behaviors. The analyzing may comprise applying predetermined screening rules.

An aspect of various embodiments of the present invention provides s a computerized system, computerized method and computer program product for detecting malware by using a computer disk to accelerate malware signature scanning from outside of a host operating system. The accelerated scanning procedures may be implemented on the computer disk to filter the intercepted disk requests. The filtering techniques can involve any type of algorithm (as desired or required) that can be used in malware detection, including an RE-tree application. RE-trees are hierarchical tree-based data structures that may provide efficient indexing for regular expressions.

These and other objects, along with advantages and features of the invention disclosed herein, will be made more apparent from the description, drawings and claims that follow.

### BRIEF DESCRIPTION OF THE DRAWINGS

The accompanying drawings, which are incorporated into and form a part of the instant specification, illustrate several aspects and embodiments of the present invention and, together with the description herein, and serve to explain the principles of the invention. The drawings are provided only for the purpose of illustrating select embodiments of the invention and are not to be construed as limiting the invention

FIG. 1 schematically illustrates a malware detection system in which the disk requests are analyzed by the disk processor.

FIG. 2 schematically illustrates a malware detection system in which the disk requests are analyzed by a virtual machine outside of the host operating system.

FIG. 3 schematically illustrates a malware detection system in which the disk requests are analyzed by both the disk processor a virtual machine outside of the host operating system.

FIG. 4 schematically illustrates the relationship between the virtual machine detection system and the disk detection system when both are used in combination and where the virtual machine detection system uses other observable guest OS activity.

FIG. 5 schematically illustrates the proposed malware detection system in relation to the executing program and the host operating system and specifies the internal detection workings that occur in either the virtual machine detection or on the disk when executed by the disk processor.

FIG. 6 schematically illustrates disk-level signatures relating to the specific W32.Taureg virus example.

FIG. 7 schematically illustrates an aspect of an embodiment of a sample detector D designed to, but not limited thereto, accelerate scanning using an RE-tree approach.

FIG. 8 schematically illustrates aspects of embodiments of three potential detector designs using, but not limited to, an RE-tree approach

### DESCRIPTION OF THE PREFERRED EMBODIMENTS

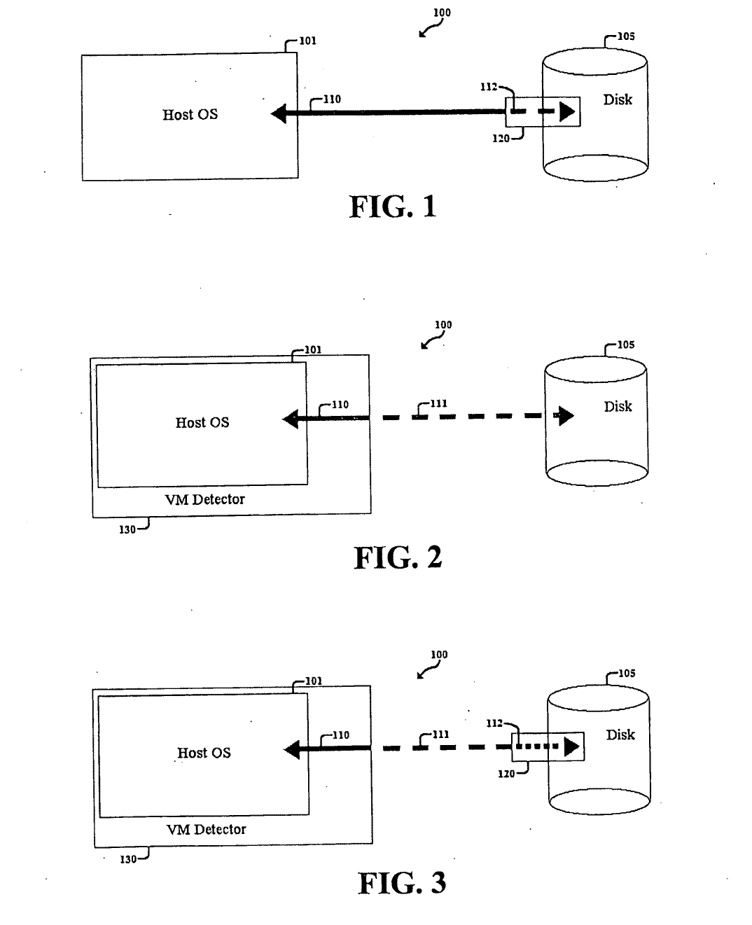

FIG. 1 schematically illustrates an aspect of an embodiment of the present invention computerized detection system 100 or related method and computer program product code that may comprise a host operating system 101 within a computer or a computer system. The host operating system 101 serves to receive disk requests 110 from file requesting programs, such as application programs, and service these requests by reading or writing to a physical device 105, such as a disk drive. The physical device 105 includes a malware detector 112 which serves to intercept the disk requests 110 before said requests are serviced. The malware detector 112 scrutinizes each disk request 110 and only allows those requests which are deemed safe 112 to be serviced by the physical device 105. The computerized detection system 100 may comprise a computer disk. The computerized detection system 100 may comprise a processor on a computer disk.

FIG. 2 schematically illustrates an aspect of an embodiment of the present invention computerized detection system 100 or related method and computer program product code that may comprise a host operating system 101 within a computer or a computer system. The host operating system 101 serves to receive disk requests 110 from file requesting programs, such as application programs, and service these requests by reading or writing to a physical device 105, such as a disk drive. Outside the host operating system 101 is a virtual machine malware detector 130 which scrutinizes each disk request 110 and only allows those requests which are deemed safe 111 to be serviced by the physical device 105. In addition, the virtual machine malware detector 130 views other observable host operating system activity to detect malware. The computerized detection system 200 may comprise a virtual machine outside of the host operating system.

FIG. 3 schematically illustrates an aspect of an embodiment of the present invention computerized detection system 100 or related method and computer program product code that may comprise a host operating system 101 within a computer or a computer system. The host operating system 101 serves to receive disk requests 110 from file requesting programs, such as application programs, and service these requests by reading or writing to a physical device 105, such as a disk drive. Outside the host operating system 101 is a virtual machine malware detector 130 which scrutinizes each disk request 110 and only allows those requests which are deemed safe 111 to be sent to the physical device 105. In addition, the physical device 105 includes a malware detector 112 which serves to intercept the disk requests 111 which where already analyzed by the virtual machine detector 130 but before said requests are serviced. The malware detector 112 scrutinizes each disk request 110 and only allows those requests which are deemed safe 112 to be serviced by the physical device 105. The computerized detection system may comprise both a virtual machine outside of the host operating system and a computer disk.

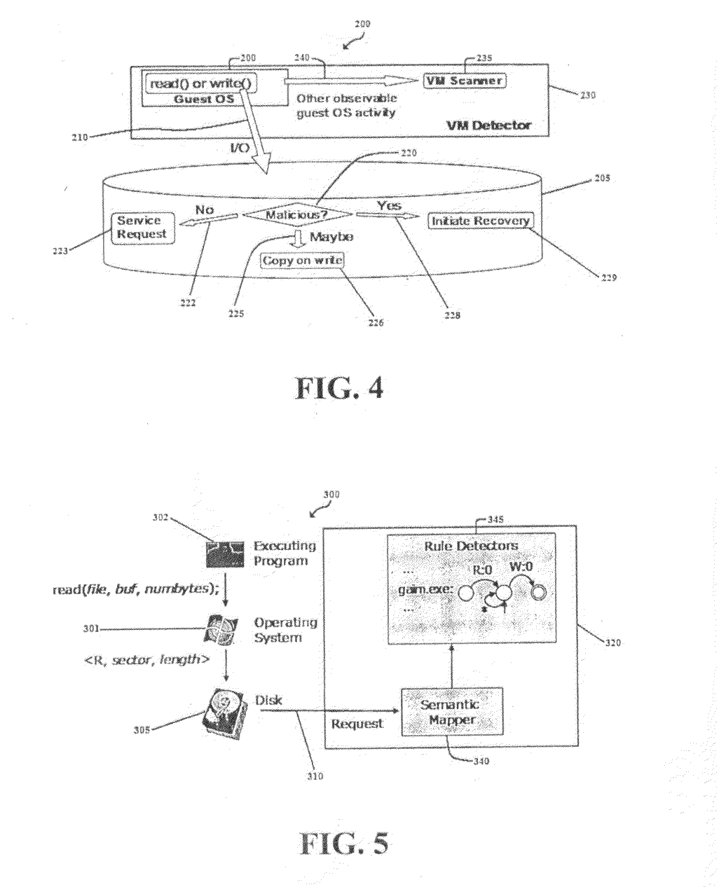

FIG. 4 schematically illustrates an aspect of an embodiment of the present invention computerized detection system 200 or related method and computer program product code that may comprise a host operating system 201 within a computer or a computer system. The host operating system 201 serves to receive disk requests 210 from file requesting programs, such as application programs, and service these requests by reading or writing to a physical device 205, such as a disk drive. Outside the host operating system 201 is a virtual machine malware detector 230 which scrutinizes each disk request 210 and only allows those requests which are deemed safe to be sent to the physical device 205. In addition, the virtual machine malware detector 230 sends other observable host OS activity to a scanner 235 to determine if the disk requests 210 are malware. The malware detector 220 makes the determination if a disk request is malicious or not. If the disk request is determined not to be malicious 222 (for example, no), the physical device 205 services the request 223. If the disk request is determined to be malicious 228 (for example, yes), the physical device takes the necessary steps to initiate response and recovery 229. If the detector cannot determine if the disk request is malicious 225 (for example, maybe), the physical device can respond by copying the original data before allowing the request to occur so as to protect the data 226 in its original state.

FIG. 5 schematically illustrates an aspect of an embodiment of the present invention computerized detection system 300 or related method and computer program product code that may comprise a host operating system 301 within a computer or a computer system. Although the Windows logo is presently illustrated, it should be appreciated that any operating system may be utilized as desired or required. The host operating system 301 serves to receive disk requests 310 from file requesting programs 302, such as application programs, and service these requests by reading or writing to a physical device 305, such as a disk drive. The disk requests 310 are analyzed by the detection system 320 using a Semantic Mapper 340 and rule detectors 345 to make the determination if a particular request 310 is malicious.

Turning to FIGS. 1-6, and throughout the disclosure, it should be appreciated that the computerized detection system and related method and computer program product for detecting malware observes behavior of the host computer system in actual program execution from outside of the host computer system. The observing of the behavior may comprise intercepting requests that are destined for the computer disk and inferring the corresponding file system actions. For instance, intercepting disk requests may comprise viewing the read and write operations sent from the host to the disk. The inferring file system actions comprise analyzing said intercepted disk requests to identify malware behaviors. The analyzing comprises applying predetermined screening rules, which further comprises at least one of the following: rules for detecting infections of Windows executable files based on the known structure of executable files and the steps needed to successfully infect an executable file, rules for detecting suspicious modifications to core system files and other critical files, and rules recognizing behavior of known malicious programs based on their disk access patterns, or any combination thereof. The computerized detection system may respond to said malware detection. The response may comprise the halting of the intercepted disk request such that halting comprises disallowing writes that are determined to be malicious. The response may comprise providing notification to the host operating system, a remote system, or a user, or any combination thereof. Malware comprises at least one of the following: Computer viruses, worms, Trojan horses, spyware, dishonest adware, and other malicious and unwanted software, or combinations thereof. Computer disk comprises any digital storage system such as a hard disk, USB disk, network disk, disk array controller, or storage appliance.

Turning to FIGS. 1-5, 7, 8, and as discussed throughout this disclosure, it should be appreciated that an alternative embodiment may involve a computerized system and related method and computer program product for detecting malware by using a computer disk to accelerate malware signature scanning from outside of a host operating system. The accelerated scanning procedures are implemented on the computer disk to filter the intercepted disk requests. The filtering techniques can involve any type of algorithm that can be used in malware detection, including an RE-tree application. RE-trees are hierarchical tree-based data structures that provide efficient indexing for regular expressions.

The terms “computer program medium” and “computer usable medium” may be used to generally refer to media such as a removable storage drive, a hard disk installed in hard disk drive, and signals. These computer program products are means for providing software to computer systems. The invention includes such computer program products. In an embodiment, computer programs (also called computer control logic) may be stored in main memory and/or secondary memory or as desired or required. Computer programs may also be received via communications interface. Such computer programs, when executed, enable computer systems to perform the features of the present invention as discussed herein. In particular, the computer programs, when executed, enable a processor to perform the functions of the present invention. Accordingly, such computer programs represent controllers of computer system. In an embodiment where the invention is implemented using software, the software may be stored in a computer program product and loaded into computer system using removable storage drive, hard drive or communications interface. The control logic (software), when executed by the processor, causes the processor to perform the function of the invention as described herein. In another embodiment, the software may be stored in a computer program product loaded into the firmware of the physical device, such as a hard drive. In particular, the computer programs, when executed by the hard disk processor or equivalent device on the physical device, enable said processor to perform the functions of the present invention. In another embodiment, the invention is implemented primarily in hardware using, for example, hardware components such as application specific integrated circuits (ASICs). Implementation of the hardware state machine to perform the functions described herein will be apparent to persons skilled in the relevant art(s). In yet another embodiment, the invention is implemented using a combination of both hardware and software. In an example software embodiment of the invention, the methods described above may be implemented in control language and could be implemented in other programs, program language or other programs available to those skilled in the art.

The computer and computer related devices, systems, program products and methods of various embodiments of the present invention disclosed herein may utilize aspects disclosed in the following patents and applications and are hereby incorporated by reference in their entirety:

1. U.S. Patent Application Publication No. US2006/0195904 A1 to Williams, L., “Data Storage Device with Code Scanning Capability,” Aug. 31, 2006.

2. U.S. Patent Application Publication No. US2007/0174915 A1 to Gribble, S., et al., “Detection of Spyware Threats Within Virtual Machine,” Jul. 26, 2007.

3. U.S. Patent Application Publication No. US2007/0180529 A1 to Costea, M., et al., “Bypassing Software Services to Detect Malware,” Aug. 2, 2007.

4. U.S. Pat. No. 6,772,345 B1 to Shetty, S., “Protocol-Level Malware Scanner,” Aug. 3, 2004.

5. U.S. Pat. No. 6,901,519 B1 to Stewart, W., “E-Mail Virus Protection System and Method,” May 31, 2005.

6. U.S. Pat. No. 6,971,019 B1 to Nachenberg, C., “Histogram-Based Virus Detection,” Nov. 29, 2005.

7. U.S. Pat. No. 7,096,368 B2 to Kouznetsov, V., “Platform Abstraction Layer for a Wireless Malware Scanning Engine,” Aug. 22, 2006.

8. U.S. Pat. No. 5,319,776 to Hile, J., et al., “In Transit Detection of Computer Virus with Safeguard,” Jun. 7, 1994.

9. U.S. Pat. No. 7,096,501 B2 to Kouznetsov, V., et al., “System, Method and Computer Program Product for Equipping Wireless Devices with Malware Scanning Capabilities,” Aug. 22, 2006.

10. U.S. Pat. No. 7,171,690 B2 to Kouznetsov, V., et al., “Wireless Malware Scanning Back-End System and Method,” Jan. 30, 2007.

11. U.S. Patent Application Publication No. US2003/0079145 A1 to Kouznetsov, V., et al., “Platform Abstraction Layer for a Wireless Malware Scanning Engine,” Apr. 24, 2003.

12. U.S. Patent Application Publication No. US2005/0188272 A1 to Bodorin, D., et al., “System and Method for Detecting Malware in an Executable Code Module According to the Code Module's Exhibited Behavior,” Aug. 25, 2005.

13. U.S. Pat. No. 7,013,483 to Cohen, O., et al., “Method for Emulating an Executable Code in Order to Detect Maliciousness,” Mar. 14, 2006.

14. U.S. Pat. No. 6,009,497 to Well, S., et al., “Method and Apparatus for Updating Flash Memory Resident Firmware through a Standard Disk Drive Interface,” Dec. 28, 1999.

Practice of the invention will be still more fully understood from the following examples, which are presented herein for illustration only and should not be construed as limiting the invention in any way.

### Example No. 1

An aspect of some of some of the embodiments of the present invention methods reduce the overhead of AV string scanning by distributing the work between the host and disk processors. Although this aspect of the invention concentrates on improving the scanning of anti-virus engines, this aspect has equal applicability in firewalls and SPAM email filters. Any type of application that must match some data according to some signature could be improved by using the disk to perform some work on its behalf. For firewalls, many rules are used to compare against network traffic to know what traffic should be blocked or allowed to pass through. Email filters must also match SPAM signatures to email traffic in order to attempt to accurately identify SPAM.

By reducing the scanning overhead the present invention methods and systems either improve overall system performance, or more likely, use the extra compute time to allow the host virus scanner to perform more sophisticated, high-overhead techniques to detect viruses that cannot be found through simple string scanning. The large size of virus signature databases means the entire database cannot be stored in the disk processor's memory. It should be appreciated that the size of virus databases is expected to continue to increase, at least as fast as the memory available on disk processors. Therefore an aspect of an embodiment may use the disk processor to assist host processor virus detection without needing to store the entire virus database on the disk processor.

An aspect of an embodiment may use the disk as a filter that recognizes a superset of the language detected by the original anti-virus engine. If the disk scanner does not recognize a string, that string is known to be outside the virus language and the host processor need not scan it at all. If the disk scanner matches a string, the host runs the original anti-virus engine on that string to determine if it is a real match.

Regarding the filter aspect, only the string scanning part of the original anti-virus engine, AV is considered. This recognizes a language comprising the suspected viruses, L(AV)=L(r₀)∪L(r₁)∪ . . . ∪L(rₙ₋₁) where r₀, r₁, . . . , rₙ₋₁ are the regular expression signatures in the virus database. Our goal is to take a string of bytes, s, that represents a sequence of bytes from a program and determine if s∉L(AV). An approach may involve trying each regular expression or virus definition with the given string s extracted from different executable content.

However, it should be appreciated that a drawback of the signature matching approach is running time, which is dependent on the number of times one must search a growing virus database (previously shown to be O(n) using a Patricia tree algorithm [Yat89, See R. Baeza-Yates and G. H. Gonnet. Efficient Text Searching of Regular Expressions. In 16^{th} International Colloquium on Automata, Languages and Programming (Springer-Verlag Lecture Notes in Computer Science 372, July 1989, of which is hereby incorporated by reference herein in its entirety.] with some preprocessed text). Since users continually install software and the virus database is continually increasing, performing these searches is expensive in the host and challenging in the disk.

Still referring to the filter aspect, finding the search string s is not important as long as the baseline system and the new system (using the inventors' new detector) both use the same algorithm to obtain s. An aspect of an embodiment of the present invention method and related system may include three methods to find the search string s: (1) incrementally scan a file as it is read and written keeping state about which parts have been scanned [Mir04, See Yevgeniy Miretskiy, Abhijith Das, Charles P. Wright, and Erez Zadok. Avfs: An On-Access Anti-Virus File System. In 13^{th} USENIX Security Symposium, August 2004, of which is hereby incorporated by reference herein in its entirety.], (2) use heuristics to identify data necessary to scan by looking at executable content, file sizes, and other information to minimize the amount of data that must be scanned [Szo05, See Peter Szor. The Art of Computer Virus Research and Defense. Addison-Wesley, 2005, of which is hereby incorporated by reference herein in its entirety.], or (3) get the string from the host machine Similar to object-based storage devices [OSD06, See Object-Based Storage Devices-2 (OSD-2). http://www.t10.org/ftp/t10/drafts/osd2/osd2r00.pdf, October 2004, of which is hereby incorporated by reference herein in its entirety.] and semantically-smart disks [Siv03, See Muthian Sivathanu, Vijayan Prabhakaran, Florentina Popovici, Timothy Denehy, Andrea C. Arpaci-Dusseau, and Remzi H. Arpaci-Dusseau. Semantically-Smart Disk Systems. In 2^{nd} USENIX Conference on File and Storage Technologies (FAST), March 2003, of which is hereby incorporated by reference herein in its entirety.]. These options require either rudimentary file system functionality within the storage system or the device understanding part of the host file system.

For the first option, an aspect of an embodiment of the present invention method may mark different blocks as being scanned or not scanned (marking the file as clean when the entire file has been scanned without being written between scans), but this incurs overhead per block. Current disk drive sizes have over a hundred million blocks (around one billion sectors), and the overhead used per block may become prohibitive; however, this method can be used as a first step towards evaluation. An alternative to storing state per block is storing state per page [See supra Mir04, of which is hereby incorporated by reference herein in its entirety.]. For the second option, an aspect of an embodiment of the present invention method is to use file heuristics used in most AV scanners. For the third option, an aspect of an embodiment of the present invention method requires communication with the host machine. Assuming the communication channel is uncompromised, some help from the host in choosing a string of bytes to examine is useful as long as the overhead of communication does not outweigh the benefit from the disk's help in scanning. For now, it is assumed that the disk processor can obtain the same scanning strings as the host processor would normally. As an analogy, in firewalls, the string s would be a network packet, in which the firewall would actually scan some subset of a full packet In SPAM filters an entire email would be scanned as the string.

An aspect of an embodiment of the present invention method and related system is to detect the original language L(AV), but to require substantially less work on the host processor. Such may be accomplished by using the disk processor to implement a filter, D, such that all strings in L(AV) are in L(D). A string that is not in L(D) is known to be outside L(AV) and need not be scanned by the host processor; a string that is in L(D) may or may not be in L(AV) and must be scanned by the host processor. A filter D may be looked for with these properties:
1. Superset. Any string that is not recognized by D is not a known virus:

L(D)⊃L(AV)
2. Effective filter. Most strings recognized by D are in L(AV): we want to minimize the probability that s∈D̂s∉L(AV) where s is distributed over the set of possible scanned strings.
3. Feasible. The filter D is small and simple enough to implement efficiently on the disk processor.

The detector may satisfy the superset requirement to ensure correctness: otherwise, the risk of missing viruses that would have been detected by the original AV increases. Filtering effectiveness and implementation costs present an engineering tradeoff: satisfying the filtering requirement using the original detector AV; satisfying the implementation requirement using D=Σ*. A challenge is to find a detector D that can filter effectively and be implemented on a disk processor. A constraint may be the size of the disk processor memory. It may be too small to hold the entire virus database, and thus an aspect of an embodiment may include minimizing the memory used since it is no longer available for the disk cache.

An aspect of an embodiment of the present invention method and related system may include an option for a detection algorithm derived from RE-trees [Cha02a, See Chee-Yong Chan, Minos Garofalakis, and Rajeev Rastogi. RE-Tree: An Efficient Index Structure for Regular Expressions. In 28^{th} Conference on Very Large Data Bases (VLDB), August 2002, of which is hereby incorporated by reference herein in its entirety.]. RE-trees are a hierarchical tree-based data structure based on a B-tree [Cor01, See Thomas H. Cormen, Charles E. Leiserson, Ronald L. Rivest, and Clifford Stein. Introduction to Algorithms. 2nd Edition. The MIT Press, 2001, of which is hereby incorporated by reference herein in its entirety.] that provide efficient indexing for regular expressions. Some example RE-tree applications are XML filtering [Alt00, Cha02b, Dia02, See M. Altinel and M. J. Franklin. Efficient Filtering of XML Documents for Selective Dissemination of Information. In 26^{th} Conference on Very Large Databases (VLDB), September 2000, C.-Y. Chan, P. Felber, M. Garofalakis, and R. Rastogi. Efficient Filtering of XML Documents with) (Path Expressions. In 18^{th} International Conference on Data Engineering, February 2002, Y. Diao, P. Fischer, M. J. Franklin, and R. To. YFilter: Efficient and Scalable Filtering of XML Documents. In Proceedings of the 18th International Conference on Data Engineering, February 2002, of which are hereby incorporated by reference herein in their entirety.], and BGP routing [Cha02a, See Chee-Yong Chan, Minos Garofalakis, and Rajeev Rastogi. RE-Tree: An Efficient Index Structure for Regular Expressions. In 28^{th} Conference on Very Large Data Bases (VLDB), August 2002, of which is hereby incorporated by reference herein in its entirety.]. But this is the first time RE-trees have been applied to virus detection. A key property in an RE-tree that is helpful in virus detection is its search-pruning attribute. During the search of an RE-tree, if a node does not recognize a string, then its entire sub-tree can be pruned from the search. Because of this search-pruning ability, an RE-tree is a good candidate data structure for our detector. Thus, one aspect may envisage techniques based on those in to adapt RE-trees to the problem of producing an effective disk virus filter [See supra Cha02a, of which is hereby incorporated by reference herein in its entirety.].

An exemplary embodiment of the present invention detector is schematically illustrated in FIG. 7 to demonstrate of aspect of the present invention approach. The leaf nodes correspond to particular virus definitions, in this example, W32.Bolzano and W32.MyLife from ClamAV [Cla06, See Clam Antivirus. http://www.clamay.net/, of which is hereby incorporated by reference herein in its entirety.]. The detector can be implemented using a cross-cut through the RE-tree. Suppose r₁ is used to implement the detector. This satisfies the subset requirement since L(r₁) is a superset of L(AV)=L(r₂)∪L(r₃). It may be an effective filter—establishing this would require analyzing how many typical scan strings are in L(r₁) but not in L(AV). A detector that recognizes L(r₁) would be smaller than a detector that recognized L(AV).

Another strategy for implementing detectors is to partially traverse the RE-tree. To search for a string s using the detector shown in FIG. 7, an aspect of an embodiment may begin at the root node by attempting to match s on all internal regular expressions. In this case, we have one regular expression is contained in the left internal node, r₁. If s matches this expression, the node pointed to by that internal node is searched. Again, an aspect of an embodiment may only have one node to search, but this node has two regular expressions, r₂ and r₃. This could continue through multiple levels of a tree until a leaf node is reached, or s does not match any of the regular expressions for a node. Matching a leaf node (r₂ or r₃) means an aspect of an embodiment may have exactly matched a virus just as the host would have done with its original virus definitions without a disk filter. A key speedup from the RE-tree is if the string does not match any regular expression in a node n, then the sub-tree of n can be pruned from the search. If s did not match r₁, then we could conclude the program containing s did not have the Bolzano or MyLife virus, since L(r₁) would recognize any string in r₂ or r₃. If the node containing r₁ was an intermediate node in the tree, the entire sub-tree of r₁ would be pruned from the search. The search can terminate at any node, and leave the remainder of the scanning to the host processor.

Each node n in a RE-tree consists of k regular expressions where L(n) is the union of the languages of the regular expressions contained by n. FIG. 8 depicts an example where each node has two regular expressions (k=2). In an RE-tree, as in this embodiment's detector, any parent node's language bounds the child node's language: L(child)⊂ L(parent). Given these properties, if a parent node does not recognize a particular string, then there is no need to continue searching—the inventors know no descendant node's language includes the string. FIG. 7's nodes used regular expressions from the ClamAV database, but had this example been a firewall or SPAM filter, the nodes could have also been regular expressions representing their respective rules. This further illustrates the invention's applicability to the more general problem of matching given strings to a set of regular expressions.

An aspect of an embodiment is to build the tree in a bottom-up manner with the leaf nodes being the original virus definitions. For real virus databases, the corresponding RE-tree will have thousands of leaves and many levels; simple, illustrative examples are used here. At the root node in FIG. 8, a superset of L(AV) is still recognized (which is the union of the leaf nodes), and the property still exists that each of the cross-cutting language L(A), L(B), and L(C) is also a superset of L(AV). D can have many possible embodiments other than the three shown here. For instance, D could have all nodes of a single level of a RE-tree (designs A and B). If none of the nodes recognize the search string s, then the conclusion is that the program containing s is not infected. Constructing such a detector from an RE-tree would be simple, but may produce an unacceptably low filtering rate (that is, it would require the host processor to scan too many strings). Therefore, another embodiment is to select nodes at different levels across the tree, to improve the filter rate for a given detector size. For example, detector C in FIG. 8 uses REs from three different levels in the tree. The trade-offs between space and precision in constructing the disk detector must be balanced.

At any time during the search, the scan can be terminated and handed off to the matching engine, or in this example, the host AV engine. At some point, either the disk detector has determined the scan string is not in L(AV) and it can be safely used without running the host detector at all, or the disk detector has gotten to a node whose children are not available on the disk detector. When the detector returns to the host, it returns the last full node searched and the nodes that matched the search string on that same level in the tree. The host can continue scanning at the node where the disk processor stops.

Regarding an exemplary approach of an exemplary embodiment of the present invention detector, the detector can be constructed off-line, so as long as the construction algorithms are tractable the efficiency of the construction is of small concern. The detector can be constructed without imposing severe time constraints each time there is a virus definition update. This is similar to the work of An et al. [An02, See N. An, S. Gurumurthi, A. Sivasubramaniam, N. Vijaykrishnan, M. Kandemir, M. J. Irwin, Energy-Performance Trade-Offs for Spatial Access Methods on Memory Resident Data. The VLDB Journal, 11(3):179-197, November, 2002, of which is hereby incorporated by reference herein in its entirety.] that explored using R-trees with spatial databases in a resource-constrained environment. A challenge, for instance, may be to produce a sufficiently small detector that satisfies the superset property but has a high filtering rate.

Since RE-trees were primarily designed for speed, an aspect of an embodiment may adapt some of the RE-tree algorithms for our purposes. Although speed is very important, a large component related to speed is the memory footprint of our approach. To minimize this memory footprint an aspect of an embodiment may tweak some of the design parameters for this data structure.

At each node, an aspect of an embodiment may need to find a set of regular expressions that bound the languages of the node's children. Ideally, the node's RE languages would have no intersection, so only the subtree corresponding to one of these REs needs to be traversed. There can be times, however, where it is not practical to use REs with non-empty intersections. This may mean that a string could match more than one regular expression in a single node and an aspect of an embodiment may search all sub-trees of the matching regular expressions.

As an aspect of an embodiment may compute bounding automata, it may strive to minimize the intersection of two regular expressions in these two cases. The trade-off may be that a more precise automaton will increase the amount of required memory. In our FIG. 7 example, the bounding automaton r₁ could have also been .*79.*656d.*6c2e.*. This would satisfy the superset property and decrease memory requirements to store the expression, but would accept a much larger language. An aspect of an embodiment may be to develop algorithms that can construct a detector that minimizes both the size of the detector and the frequency multiple sub-trees will need to be searched by balancing memory and false positives. This may involves studying or providing a number of trade-offs between precision, space, and running time. Parameters may include the minimum and maximum allowed REs, the number of states in a regular expression, the false positive rate of a regular expression, and the language intersection of the REs.

An aspect of an embodiment may construct D starting from the original virus signatures. A first step may be to build an RE-tree that has all the original virus definitions as its leaf nodes. Note the arrangement of the virus definitions at the bottom of this RE-tree directly impact the size and precision of D. Once the RE-tree is constructed, an aspect of an embodiment may need to select the subset of the nodes that will be implemented on the disk processor. When an aspect of an embodiment may choose the nodes for inclusion in D, their false positive rates will be directly impacted by the ordering of the original virus definitions at the bottom of the RE-tree. An aspect of an embodiment may choose algorithms to help pick the orderings of the virus definitions and then include the best nodes of the RE-tree in D.

Another important algorithm for RE-trees is computing a bounding automaton (or parent regular expression) for a given set of regular expressions. An aspect of an embodiment may have an algorithm [See supra Cha02a, of which is hereby incorporated by reference herein in its entirety.] to compute bounding automata from the regular expressions in a child node, but an aspect of an embodiment may carefully tweak this algorithm to minimize false positives. For instance, there may be a merging of states in the bounding automaton where the resulting finite state machine (FSM) has more states than the minimal DFA, but the false positive rate is much lower. An aspect of an embodiment may accept a larger FSM to reduce the false positive rate. As a corollary, an aspect of an embodiment may involve shrinking the FSM that bounds a child node at the cost of more false positives. One option is to change this greedy algorithm to balance false positives and memory usage when computing a bounding automaton.

Next, referring to disk and host communications, generally, communication between the disk and host is limited to read/write requests and responses. An aspect of an embodiment may depend on richer forms of communication between the host and the disk. Object-based storage devices [See supra OSD06, of which is hereby incorporated by reference herein in its entirety.], provide more commands for the host to interact with the disk. An aspect of an embodiment may extend the proposed OSD specifications to support our needed two-way communication. In filtering, the disk may need to know more information to form the search string s (in the following section, the disk may also need semantic information for disk-level signatures). Current commodity disks do not support OSD interfaces, but the standard has been approved by disk manufacturers and is expected to be supported by future products.

### Example No. 2

An advantage of a dynamic disk-level approach in some of the various embodiments of the present malware detection system and related method is stopping viruses like W32.Funlove or others that can spread via network shares. Some techniques in stopping viruses like Funlove or others include using firewall rules [See supra Szo05, of which is hereby incorporated by reference herein in its entirety.], but an aspect of an embodiment may stop this at the disk without relying on network defense measures. If successful, recognizing a virus and its variants with disk-level signatures will be a big performance and reliability gain. Viruses like W32.Junkcomp or W95.Drill or others that are polymorphic and use anti-emulation techniques may be reliably detected using disk-level signatures. Other types of malware detection may also benefit from these techniques like macro virus detection [Sza02, See Gabor Szappanos. Are There any Polymorphic Macro Viruses at all? ( . . . And what to do with them). In Virus Bulletin Conference, September 2002, of which is hereby incorporated by reference herein in its entirety.] and .NET/Java virus detection [Fer04a, Fer04b, See Peter Ferrie. Let them eat Brioche. Virus Bulletin (http://www.virusbtn.com), November 2004, Peter Ferrie. Look at that Escargot. Virus Bulletin (http://www.virusbtn.com), December 2004, of which are hereby incorporated by reference herein in their entirety]. Emulating Microsoft macros or virtual machines like .NET or Java requires significant effort. Further, many virus authors use a variant even when they do not fully understand the original source code. Altering disk-level behavior requires more difficult changes than altering the static virus code. Because these disk-level signatures capture the virus behavior, many variants of a polymorphic virus could be detected with a single disk-level signature.

Since the disk processor is three to four generations behind current processors [Rie98, See Erik Riedel, Garth Gibson, and Christos Faloutsos. Active Storage for Large-Scale Data Mining and Multimedia. In 24^{th} Conference on Very Large Databases (VLDB), August 1998, of which is hereby incorporated by reference herein in its entirety], the required processing of these signatures may worsen the disk I/O response time by a noticeable amount. Therefore, care may be taken so that the user would not experience a degrading of performance from the use of disk-level signatures. [taken from top of page 26-top of page 27 of provisional]

Behavioral signatures based only on reads or writes are not likely to be precise enough to identify viruses without additional semantic information. Signatures without any semantic information may only be able to detect a small subset of viruses that have sufficiently unique disk access patterns to have signatures with a low enough false positive rate. Knowing what blocks map to in the file system should help decrease false positives, and an aspect of an embodiment may use semantic information to augment our signatures. An aspect of an embodiment may even use dynamic disk-level signatures that make use of limited semantic information. Instead of just trying to learn information from disk block locations, an aspect of an embodiment may use higher-level semantics that have to do with the underlying file system. While this does require the disk to be aware of some aspects of the file system, it does not require complete knowledge.

Initially, an aspect of an embodiment may develop signatures manually by inspecting virus source code and tracing the I/O behavior of its executions. Since behavioral signatures are different from static signatures, an aspect of an embodiment may envision an appropriate formal notation for recording behavioral signatures.

To scale an exemplary approach, however, an aspect of an embodiment may automate the generation and testing of disk-level virus signatures. Dynamic inference techniques may be useful for automatically generating candidate signatures by observing sample executions of a virus under different conditions, and for automatically culling signatures with high positive rates by testing candidate signatures on a corpus of traces of benign executions.

Previous work also studied finding disk block access correlations, including C-Miner [Li04, See Zhenmin Li, Zhifeng Chen, Sudarshan M. Srinivasan, and Yuanyuan Zhou. C-Miner: Mining Block Correlations in Storage Systems. In 3^{rd} USENIX Conference on File and Storage Technologies (FAST), April 200, of which is hereby incorporated by reference herein in its entirety.] and FABS [Sta05, See Paul T. Stanton, William Yurcik, and Larry Brumbaugh. FABS: File and Block Surveillance System for Determining Anomalous Disk Accesses. In 6^{th} IEEE Information Assurance Workshop, June 2005, of which is hereby incorporated by reference herein in its entirety.]. Although neither of these was developed to detect viruses, they include techniques for analyzing disk access patterns. The goal of FABS is to find correlations among blocks and then to recognize anomalous malicious disk accesses. C-Miner was designed to improve directed prefetching and data layout, but one issue with the C-Miner design is that it breaks up a given trace to search for malicious sub-sequences in the longer trace by breaking up the longer trace into non-overlapping smaller traces. The problem is that this will increase the false negative rate when a sequence of malicious blocks lies between two adjacent windows that could be covered if overlapping windows were used [Li04, See Zhenmin Li, Zhifeng Chen, Sudarshan M. Srinivasan, and Yuanyuan Zhou. C-Miner: Mining Block Correlations in Storage Systems. In 3^{rd} USENIX Conference on File and Storage Technologies (FAST), April 2004, of which are hereby incorporated by reference herein in their entirety.]. Another possibility is to use more general dynamic inference techniques, such as the approach we developed for inferring temporal properties from program traces [Yan04a, Yan04b, Yan06, See Jinlin Yang and David Evans. Dynamically Inferring Temporal Properties. In ACM SIGPLAN-SIGSOFT Workshop on Program Analysis for Software Tools and Engineering (PASTE). June 2004, Jinlin Yang and David Evans. Automatically Inferring Temporal Properties for Program Evolution. In 15^{th} IEEE International Symposium on Software Reliability Engineering (ISSRE). November, 2004, Jinlin Yang, David Evans, Deepali Bhardwaj, Thirumalesh Bhat, and Manuvir Das. Perracotta: Mining Temporal API Rules from Imperfect Traces. In 28^{th} International Conference on Software Engineering (ICSE), May, 2006 of which are hereby incorporated by reference herein in their entirety.].

### Example 3

Four areas of contribution for disk-level behavioral detection addressed may include: developing methods for (1) manual generation of disk-level signatures, (2) automatically deriving disk-level signatures, (3) expressing disk-level signatures, and (4) checking disk-level signatures. In this section, our construction of these signatures is motivated by using W32.Tuareg as an example virus [See Dri00, Mental Driller. Tuareg Virus. November 2000, of which is hereby incorporated by reference herein in its entirety.]. W32.Tuareg is a polymorphic virus that uses garbage instructions and employs anti-emulation tricks. Tuareg's polymorphic engine has been used in other viruses (such as W95.Drill). A disk-level behavioral signature to Tuareg was developed such that it can efficiently detect Tuareg as well as many possible variants. The signature was developed starting with a disk-level signature using only reads and writes and progressively build better signatures using more semantic information. At the level of the disk with no semantic information, I/O will be in the form of <r/w, disk block, length> where the request will begin reading or writing to or from disk block for the given length of blocks. With Tuareg, detection may be possible through the information provided by the actions, or payload, that it takes for infection. One defining characteristic with Tuareg's payload is that the payload is not executed unless execution happens on a Friday during the first or third week of the month. The disk's internal clock can be used for a quick check to see if the time is correct. Among other things, the payload of Tuareg changes the Internet Explorer and the Netscape Navigator homepage to point to a specific website by modifying specific registry keys. The actions Tuareg uses in its payload include finding all *.exe, *.src, and *.cpl files in the windows, windows\system, and current directories as well as any programs set to execute at startup. Other characteristic actions include opening the Internet Explorer and Netscape registry keys associated with their home pages, infecting every other fourth file (instead of every file found), and deleting four specific commercial AV files used for checksumming.

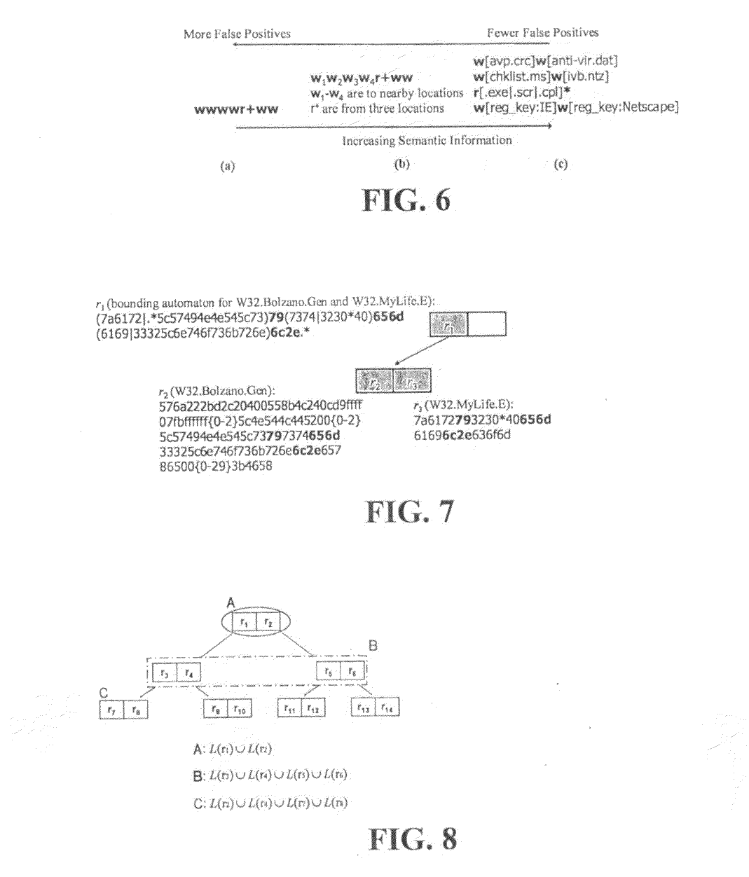

FIG. 6 shows three different possible disk-level signatures for Tuareg that were developed through manual inspection of Tuareg's source code and a detailed published analysis [Szo01, See Peter Szor. Drill Seeker. Virus Bulletin (http://www.virusbtn.com), January 2001, of which is hereby incorporated by reference herein in its entirety.]. In FIG. 6(A), the I/O actions of Tuareg are captured by the signature w⁴ᵣ⁺ww. It should be appreciated that this is an illustrative and non-limiting example. This figure illustrates an example of the types of signatures that would be generated, but is not meant to denote a complete actual signature. Every element in the signature represents a particular disk block that is read or written. Knowing there will be four writes, one or more reads, and two writes, the behavior can be identified, but this signature would give a high amount of false positives since many legitimate programs would have the same behavior. By increasing the amount of semantic information that is used, it can be determined that the first four writes are to the same spatial location on the disk, and can further prove that multiple reads (r⁺) are from three specific disk block locations (windows, windows\system, and current directories), as shown in FIG. 6(B). The last signature, FIG. 6(C), uses additional specific information: the four writes in the signature correspond to deleting files used by AV engines on the host and the sequence of reads is Tuareg searching for .exe, .scr, and .cpl files and infecting the current, windows, and windows/system directories. If four requested writes (metadata updates are usually synchronous) are seen, immediately followed by reads clustered in three different locations, followed by two writes close to each other (both are in registry), then the program may be flagged as the Tuareg virus and block the writes. Because there is limited memory in the disk, a lot of state about the I/O cannot be stored. Instead, the I/O will proceed to a mirrored copy of the file with the write updates, and then merge the updated file with the original file once we are certain the signature is not matched.

For further precision, additional information can be added about the data that is read and especially what is written. Many Win32 viruses modify executable files in similar ways (e.g., adding new sections) for infection [See supra Szo05, of which is hereby incorporated by reference herein in its entirety.]. Tuareg modifies the executable file by changing the last section's name to a random character followed by “text” or a period followed by five random characters. File sizes can be incorporated with these behaviors as well, since many virus infections change the file size by a fixed amount of bytes. The first two versions of the Drill virus (based on the Tuareg polymorphic engine) always had a last section of 0x6000 bytes making it easier to come up with a precise signature.

### Example No. 4

An aspect of an embodiment may include, but is not limited to the following: (1) the disk processor being used to provide protection from unrecognized viruses or other malicious programs that initially infiltrate the computer system but are recognized at a later time, (2) the disk processor being used to enable recovery to a recent clean system state, and (3) low-level disk accesses available to the disk processor being used to detect rootkits.

An aspect of an embodiment may include programming the disk processor to prevent an attempt to modify critical system files. Information about protected blocks could be communicated to the disk processor at the installation time of the disk-level anti-virus engine. After installation, the disk would continuously monitor all I/O to the blocks associated with these files and suppress any attempt to write to or delete them. But there may be times when an aspect of an embodiment may want to modify such files for legitimate reasons (such as an OS software upgrade or patch). To provide a higher level of assurance, an aspect of an embodiment may envision a slight hardware modification. When a process attempts to write to a protected block, the disk could delay the request and signal the OS to display an authorization dialog. The user could override the suppression via an explicit keyboard command, similar to the Ctrl-Alt-Delete mechanism used to open the login dialog in Windows. The security depends on this keyboard command, for example Ctrl-Alt-Delete-Insert, being directed directly from the keyboard to the system motherboard to a signal to the disk drive without ever going through the host processor. This provides a channel the user can use to authorize the write directly to the disk that cannot be subverted by the host, even if the running kernel is compromised.

An aspect of an embodiment may enable the recovery when malware is detected using a disk-level behavioral signature that included some writes. This situation is easily dealt with using a short-term cache to record original values of overwritten blocks, and copying the original values back to the disk when the virus is recognized. An aspect of an embodiment may also enable recovery for a situation when the malware infection is detected externally, after the malware may have already corrupted other parts of the system. This can lead to viral infection or even rootkit installation, which could persist across system reboots [Rut06a, Hog05, See Joanna Rutkowska. Rootkit Hunting vs. Compromise Detection. January 2006. http://invisiblethings.org/papers/rutkowska_bhfederal2006.ppt, Greg Hoglund and James Butler. Rootkits: Subverting the Windows Kernel. Addison-Wesley, 2005, of which are hereby incorporated by reference herein in their entirety.]. In such situations, it may be important to be able to checkpoint (backup) the data in the system adequately enough to be able to recover it to a clean state, preferably to one that is as close as possible (temporally) to the state prior to infection.

An aspect of an embodiment may use techniques that could automatically identify files that would need to be check-pointed and store them in a part of the disk drive that is not directly accessible from the outside world. Heuristic techniques could be developed that can act as triggers to create the checkpoints, the parts of the file/object that would actually need to be check-pointed. There can be a variety of triggers for initiating a checkpoint operation. A simple approach would be to backup all data that are modified (and have not been detected to be malicious by any of the previously proposed detection techniques). This approach is used by the S4 system described in references Str00, Pen03, [See J. D. Strunk, G. R. Goodson, M. L. Scheinholtz, C. A. N. Soules, and G. R. Ganger. Self-Securing Storage: Protecting Data in Compromised Systems. In 4^{th} Symposium on Operating Systems Design and Implementation (OSDI), October 2000, Adam Pennington, John Strunk, John Griffin, Craig Soules, Garth Goodson, and Gregory Ganger. Storage-based Intrusion Detection: Watching Storage Activity for Suspicious Behavior. In 12^{th} USENIX Security Symposium, August 2003, of which are hereby incorporated by reference herein in their entirety.], and can be used if disk capacity is plentiful. In order to optimize for capacity, this check-pointing approach can be refined by backing up only executable and log files and ignoring those that are less likely to be the target of an infection (e.g., text-files).

An aspect of an embodiment involves storing such checkpoints on the disks in ways that are hidden from the host OS. In one aspect of an embodiment, the disk can create a special partition for storing checkpoint data that is not visible to the host. This partition could be fixed or flexible, whereby parts of it can be given to the host system by the disk drive in the event that the host-accessible capacity is nearly full. In another aspect of an embodiment, the disk drive can use disk blocks that are already reserved for internal use within the drive (e.g., spare sectors and tracks). The advantage of this embodiment is that it can be implemented in a manner that is completely transparent to the host system. In fact, nearly a third of the total pre-formatted capacity of disk drives is consumed by such blocks [Gur05, See S. Gurumurthi, A. Sivasubramaniam, V. Natarajan, Disk Drive Roadmap from the Thermal Perspective: A Case for Dynamic Thermal Management. In International Symposium on Computer Architecture, June, 2005, of which is hereby incorporated by reference herein in its entirety.].

After compromising a system, an adversary might install a rootkit to retain stealth access to the system. Since rootkits often modify the host OS to achieve stealth, it is challenging to detect their presence and remove them from the system. Current rootkit detection tools like Strider Ghostbuster [Wan05, See Yi-Min Wang, Doug Beck, Binh Vo, Roussi Roussev, and Chad Verbowski. Detecting Stealth Software with Strider Ghostbuster. MSR-TR-2005-25, of which is hereby incorporated by reference herein in its entirety.], RootkitRevealer [Cog06, See Bryce Cogswell and Mark Russinovich. Sysinternals RootkitRevealer. http://www.sysinternals.com/utilities/rootkitrevealer.html, of which is hereby incorporated by reference herein in its entirety], and Blacklight [Bla06, See F-Secure. Blacklight. http://www.f-secure.com/blacklight/, of which is hereby incorporated by reference herein in its entirety.] attempt to detect their presence by doing a two-level scan of critical kernel data structures like the Master File Table, Windows Registry, and the kernel process list, and looking for discrepancies. The high-level scan is done using the Windows API or the shell and the lower level one via a special device driver that communicates directly with the disk drive. However, there is nothing preventing an attacker who has compromised a host from installing a rootkit that intercepts the low-level device driver and masquerade the contents of the data structures that are being scanned.

An aspect of an embodiment may assist in this rootkit detection process by performing the low-level scan using the disk processor directly, thereby providing a true view of the stored data. In order to accomplish this, the disk needs to be informed, perhaps at the time of OS installation, about the location of the data blocks of the objects that would be scanned. The disk can report the results from this low-level scan to the host-system via trusted computing platform secure I/O channels. But, this communication link could itself be vulnerable to compromise. So another aspect of an embodiment may involve offloading the two-level scanning procedure to the disk processor. A discrepancy in the scanning processes can be reported to the host or the user via a non-maskable interrupt.

### Example No. 5

An aspect of an embodiment may involve recovery from detected malicious I/O traffic without interaction from the AV engine. The disk can suspend all disk I/O. Once users observe the system has frozen from the suspended disk, they will most likely perform a reboot, erasing the malware from the system. This will likely eradicate the malware, since the disk prevented it from ever writing to the disk. If the virus activity can be isolated, the disk can continue to service regular disk I/O while denying disk access to the malicious process performing I/O. For instance, a non-limiting and illustrative aspect of an embodiment may involve Dynamically Analyzing Disk Drive I/O (DADDIO) while offloading the CPU workload and aiding in low-level malware detection. DADDIO can provide interfaces to the AV engine to perform string matching and for viewing the low-level filesystem details, and it will analyze disk I/O for malicious activity. If the AV uses software interfaces to DADDIO, then the aspect of the embodiment must use a TPM to use DADDIO securely.

Another aspect of an embodiment may involve leveraging DADDIO without a TPM. To perform services on behalf of the host AV engine, DADDIO can throttle its own execution workload if the I/O performance suffers. DADDIO's other main action of scanning for malicious disk I/O can be performed during each write to the disk. Reads are less relevant if one assumes no malicious blocks exist on the disk before DADDIO is activated and DADDIO can prevent malicious writes to the disk.

An aspect of an embodiment may involve recovery from detected malicious I/O traffic without interaction from the AV engine. DADDIO can suspend all disk I/O. Once users observe the system has frozen from the suspended disk, they will most likely perform a reboot, erasing the malware from the system. This will likely eradicate the malware, since DADDIO prevented it from ever writing to the disk. If the virus activity can be isolated, DADDIO can continue to service regular disk I/O while denying disk access to the malicious process performing I/O.

### Example No. 6

An aspect of an embodiment involves processing requests that reach the disk and are processed by the disk detector. To reduce the performance impact, this processing may be done during the time the disk is performing the seek, but should be completed before any data is returned to the host. In order to recognize malware, the detector needs more information about the request than just the sector address. For example, it may need to know the name and type of the corresponding file. The semantic mapper maintains information on the file system running on the disk and maps a low-level request into a meaningful file system-level request including a file and offset. Then, the detector updates the appropriate state machine according to the request. There is one state machine for the general infection rule for each active executable file. When a state machine reaches an accepting state, a likely infection attempt has been recognized.

The state machine may provide a simple behavioral rule that detects file infections (e.g., the Update-Header Rule) instantiated for the executable file gaim.exe. After the matching read request, the state machine has advanced to the second state, where a matching write request will be recognized as an infection. Other state machines similar to this one exist for all other active executable files; they are instantiated in response to the first disk request to the file.

Because the detector is running at the disk-level, it can prevent any writes from a suspected malicious program from reaching the physical media. An aspect of an embodiment is that the disk can store recovery information in a safe backup area that would only be accessible to the disk processor. The disk may also notify the user when a virus is detected. An aspect of an embodiment could use a small display (or even LED lights) on the disk drive to notify the user of a matched virus. This assumes that the disk drive is somewhere visible to the user. Another aspect of an embodiment may involve he disk simply stopping servicing requests, which force a reboot and wipe the malware from memory.

### Example No. 7

An aspect of an embodiment may involve applying predetermined screening rules to determine malware behavior. For instance, four rules, the RRWW rules, the RWW rules, the Write-Anywhere rules, and the Update-Header rules may be used to detect malware. Additional rules may also be used in malware detection.

An aspect of an embodiment may involve whitelisting specific disk behaviors that are associated with known, trusted activities, ideally using cryptographic signatures to ensure that virus authors cannot exploit these exceptions. The approach of characterizing a general file-infecting behavior, and using a whitelist to allow certain non-malicious virus-like programs, is a promising alternative to the traditional approach of allowing all programs except for those included in a list of signatures of known malicious programs.

### Example No. 8

A virus could be designed to evade an aspect of an embodiment of the claimed invention by performing disk activity in a way that does not match our detection rule. For instance, a virus could create a new data file and then copy it over an existing executable. To detect these viruses, either an aspect of an embodiment could track data flow behavior more deeply or design general behavioral rules to capture viruses that replace existing files. Another aspect of an embodiment would be to develop a more specific signature for a known overwriting virus.

Other copying and moving strategies can be conceived. For example, a virus could read in a target executable and write out information to a temporary file. After the next reboot, it could read the temporary file for information about the file that was initially read. Then the virus could simply replace the targeted executable with an infected copy. If such viruses are released, an aspect of an embodiment could involve more sophisticated detection rules that track information flow through the disk across copies, moves, and renames. Since the detection rule states are maintained by the disk, they could persist across reboots.

Because an aspect of an embodiment involves running the detector on the disk processor, circumvention in the form of not seeing disk requests is not a problem because the disk processor sees all disk requests. One possible circumvention approach of malware creators would be to compromise the disk detector itself by altering its firmware. Disk firmware can be upgraded, but doing this is a rare and restricted operation where the host processor updates the firmware through special commands while the disk processor runs off code copied to its RAM [See Wells99, S. Wells, V. Kynett, T. Kendall, R. Gamer, D. Brown. Method and Apparatus for Updating Flash Memory Resident Firmware through a Standard Disk Drive Interface. U.S. Pat. No. 6,009,497, of which is hereby incorporated by reference herein in its entirety.]. A disk providing disk-level malware detection would need to change the method of firmware updates. Therefore, an aspect of an embodiment would involve simply changing this procedure to have the disk processor perform the update itself and check signatures of proposed updates.

### Example No. 9

Slow infections can be very difficult to detect. If the detector maintains state that expires over time, then the malware can wait out the expiration period before executing the next event. An aspect of an embodiment would maintain state for all active executable files indefinitely.

Another type of resource exhaustion attack would attempt to overwhelm the disk processor with meaningless traffic in order to hide a few malicious requests. To prevent this, an aspect of an embodiment would be designed such that requests are delayed until they can be analyzed by the detector.

Practice of the invention will be still more fully understood from the following test results, which are presented herein for illustration only and should not be construed as limiting the invention in any way.

### Experimental Test

The general behavior of a file-infecting virus is dictated by the structure of a Windows executable, which follows the PE file format depicted in Table 1. The first block is a header that contains information about the structure of the target file. The rest of the executable file is broken into sections (e.g. code, data) marked as Section 0 to Section N in Table 1. The section headers indicate the size and location of each section.

TABLE 1
Windows PE file format.

| | | | | | | |
|---|---|---|---|---|---|---|
| MS-DOS | PE | Section | Section 0 | Section 1 | . . . | Section N |
| Header | Header | Headers | | | | |

A general characteristic is that a virus must first read the header of an executable file to gather useful information in order to reliably infect files. For example, cavity-infecting viruses will use this information to examine a section to find exploitable slack space between sections. Hence, the first event expected in a file infection is a read from the file header, which is visible to the disk as a read at file offset 0.

In order to modify the executable, the virus must also write to it. Most reliable infection strategies require also modifying the file header. For example, one simple infection strategy is to infect an executable by pre-pending or appending a new section. If a virus infects using one of these methods but does not update the file header, Windows will detect that the executable is not a valid application and will not load it. Consequently, it is necessary to modify the file header if any new sections are added to the file. Another infection technique is to find slack (unused) space at the end of a section in an executable section and append the virus to an existing header. Even this, however, still requires updating the header. According to the executable file format, the unused portion should be (and is) filled with zeroes [Mic06, See Microsoft Portable Executable and Common Object File Format Specification. http://www.microsoft.com/whdc/system/platform/firmware/PECOFF.mspx, of which is hereby incorporated by reference herein in its entirety.]. If this area is not zeroed out, Windows will not throw an error on the program's execution, but the code will not be loaded into the program's address space [Szo05, See Peter Szor. The Art of Computer Virus Research and Defense, Addison-Wesley, 2005, of which is hereby incorporated by reference herein in its entirety.]. Thus, the header must be updated to increase the virtual size of an infected section when writing to its slack space.

Another reason a virus may write to the beginning of a file is to insert a file marker. Some viruses modify one or more bytes in a header in order to know if the file has already been infected. W32.Zmist, for example, writes a ‘Z’ at offset 0×1C in the header [See Szor05 supra, of which is hereby incorporated by reference herein in its entirety.]. Some anti-virus programs provide virus authors with an additional explicit motivation to both read and write into the file header. For example, Kaspersky uses weak checksums of 10-12 bytes that are written into the file header to avoid the need to rescan files [Kas05, See Kaspersky Anti-Virus Engine Technology. 2005. http://www.opsec.com/solutions/partners/downloads/Kaspersky_EngineTech_WP.pdf, of which is hereby incorporated by reference herein in its entirety.]. A virus can easily change these checksums (as was done by W32.Chiton, which recalculates and updated the file's checksum after infection [Fer06, See Ferrie, 2002a, Peter Ferrie. Attack of the Clones. Virus Bulletin. Sept. 2002, of which is hereby incorporated by reference herein in its entirety.]). This illustrates a nice synergy between a behavioral detector and traditional static detectors: a static detector could check a file property that a virus cannot maintain without generating a recognizable disk-level event that would be observed by the behavioral detector.

Hence, most infecting viruses will likely be read and write to the file header, and to also write somewhere else in the file. This behavior is captured by the RWW Rule as follows:
read [name@0];
write [name@0], write [name]
   where name is any executable file

The first read from block 0 matches the read to learn the file structure. The first write to block 0 matches the update of the executable file's header, and the rest of the writes match the rest of the virus being added. The rule notation uses a semi-colon for sequencing (the read must happen before the writes), and a comma to separate events that may happen in any order (the write to the header may happen before or after the write that injects the virus code). Any number of other events may occur between events that match the rules. For example, this rule will still match if there are additional reads after the first read or between the writes, or if there are more than two writes.

A somewhat stricter rule includes an additional read. Most viruses will need to both read the header to determine the executable structure, and then read to another location in the file to identify code to change to insert a jump to the virus. For example, an entry-point obscuring virus can overwrite a jmp instruction to jump to its code. [Szo96, See Peter Szor. Nexiv_Der: Tracing the Vixen. Virus Bulletin, April 1996, of which is hereby incorporated by reference herein in its entirety.]. To capture this additional expected read, the RRWW Rule is defined as follows:
read [name@0], read [name];
write [name@0], write [name]

In addition to these two rules, an aspect of an embodiment considers two rules that relax the requirements on the infection behavior. Relaxing the requirements makes it more likely that the rules will detect virus infections, but also increases the likelihood that the rules will match benign behaviors.

First, an aspect of an embodiment eliminates the requirement for two writes in the RWW rule. If a virus can fit its data at the beginning of the file, it could infect a file with a single write. The Update-Header Rule captures this as follows:
read [name@0];
write [name@0]

Another aspect of an embodiment involves a rule that removes the requirement that the virus read the target file at all. In theory, a virus could attempt to infect a file without reading the header by guessing where to insert code. An aspect of the embodiment captures this using the Write-Anywhere rule that matches any write to an existing executable file:
write [name]

This behavior usually leads to the undesirable behavior of the application crashing. Thus, such viruses that do not read the file header are rare and do not propagate effectively [See Szor05 supra, of which is hereby incorporated by reference herein in its entirety.].

To test the accuracy of the rules their detection rates against a corpus of malware were measured. Table 2 summarizes our detection results.

TABLE 2
Detection Results. The results indicate the percentage of test
infections of the given viruses detected by each rule. All infections
of all of the viruses are detected by the Update-Header and
Write-Anywhere rules. Viruses marked with a * perform some
malicious disk activity before the file infection activity that
is detected by the rule.

| | | | | |
|---|---|---|---|---|
| | | | Update- | Write- |
| | | | Header | Anywhere |
| Virus | RRWW | RWW | (RW) | (W) |

| Alcaul.o, Chiton.b, Detnat, | All infections detected | | |
|---|---|---|---|
| Enerlam.b, Ganda, Harrier, | | | |
| Jetto, Magic.1590, Matrix.750, | | | |
| Maya.4108, NWU, Oroch.5420, | | | |
| Parite.b*, Resur.f, Sality.l*, | | | |
| Savior.1832, Seppuku.2764, | | | |
| Simile, Tuareg (19 viruses) | | | |
| Aliser.7825 | 70% | 83% | All infections |
| | | | detected |

| | | |
|---|---|---|
| Efish* | 87% | All infections detected |
| Evyl | 91% | All infections detected |

Seventy randomly selected samples were selected from a large virus repository [Off07, See Offensive Computing. http://www.offensivecomputing.net/, of which is hereby incorporated by reference herein in its entirety.], and eliminated those that did not execute (e.g., the virus had dependencies on a specific version of kernel32.dll), those that did not infect files upon execution, and those that appeared to be minor variants of others in our sample. This left 17 valid samples. Additionally, we checked five viruses we had previously chosen for study (Detnat, Efish, Ganda, Simile, and Tuareg). Four of our 22 samples are found on the latest wildlist [Wil07, See The Wildlist Organization International. http://www.wildlist.org/WildList/200706.htm, of which is hereby incorporated by reference herein in its entirety.] (Detnat, Ganda, Sality, and Parite).

Each virus was run individually while its effect on some planted goat files (files placed specifically for infection) was observed to generate multiple infections. If a virus was detected, the detector would simply output that a virus had infected a specific file.

In these experiments the Update-Header and the Write-Anywhere rules were able to match all viruses in the test set. The RRWW and the RWW rules failed to detect some infections of three of the viruses. Although the majority of infections were matched, these viruses infected some of the goat files without detection. The virus itself always makes multiple reads and writes, but because the OS may merge disk requests the behavior observed by the disk detector does not always exhibit multiple reads and writes. For the Evyl virus, the RRWW rule missed four of 47 virus infections due to the reads being merged by the OS into a single read event. Similarly, six infections by Aliser.7825 were missed by the RRWW rule due to merged reads. For the Efish virus, the RWW rule missed 8 out of 47 infections because of merged writes; the RRWW rule missed those infections as well as an additional 6 infections because of merged reads. Requests are merged based on various factors in the OS including other pending disk requests, but it is more likely the requests are merged if the goat file is small. Hence, the results are non-deterministic, but appeared to be fairly stable across our repeated experiments.

Three of the viruses—Parite.b, Sality.l, and Efish—performed malicious disk activity, such as dropping file or creating a registry key, before the infection rule matched. Although these types of disk activity are unwanted, they do not exhibit serious malicious behavior if the infection is stopped.

The false positive rate for the detector was evaluated by testing the detection rules against collected traces of disk activity. The activity was recorded using a modified file system filter driver of the Minispy filter driver included in the Microsoft Installable Filesystem Kit [IFS07, See Microsoft Installable File System Kit. http://www.microsoft.com/whdc/devtools/ifskit/default.mspx, of which is hereby incorporated by reference herein in its entirety.]. This disk activity came from disk-level traces of eight different users for a period between one week and up to over three months for each user, comprising over 94 million disk events. Six users were computer science graduate students, and two were more typical computer users. Their activities included updating and installing programs, browsing the web, reading and sending email, instant messaging, writing papers, developing software, and listening to audio streams.

TABLE 3
False Positives Results.

| | Active | Disk | False Positives | | | |
|---|---|---|---|---|---|---|
| | Time | Events | | | Update- | Write- |
| User | (hours) | (millions) | RRWW | RWW | Header | Anywhere |
| 1 | 52 | 9.4 | 2 | 13 | 33 | 43 |
| 2 | 25 | 11.7 | 1 | 1 | 1 | 4 |
| 3 | 12 | 4.7 | 0 | 0 | 0 | 0 |
| 4 | 311 | 11.2 | 0 | 1 | 1 | 8 |
| 5 | 110 | 23.4 | 0 | 0 | 0 | 0 |
| 6 | 44 | 2.3 | 0 | 0 | 0 | 0 |
| 7 | 61 | 10.0 | 0 | 0 | 0 | 0 |
| 8 | 22 | 22.0 | 0 | 0 | 0 | 63 |
| Total | 637 | 94.7 | 3 | 15 | 35 | 118 |

Table 3 summarizes the false positives reported for each rule on each user's traces. Over 637 total hours of recorded disk activity, the RRWW rule encountered about one false positive for approximately 212 hours of active computer use. The other rules match more benign activity, encountering one false positive in 46 hours of active computer use for the RWW rule, 14 hours for the Update-Header rule, and 5 hours for the Write-Anywhere rule.

The observed false positives all resulted from four types of activities: updating programs, system restores, installations, and software development. Table 4 summarizes the causes of false positives for each rule. Four of the eight users (accounting for over 40 million total events) experienced no false positives with any rule. Two users experienced 65 total false positives from Windows updates with the Write-Anywhere rule, but 63 of these false positives came within an approximate six minute period during a single update. A third user experienced 43 false positives, 33 resulting from having the system restoration feature turned on with the Update-Header rule. These 33 false positives occurred in groups ranging from two to eight false positives across several different days. These false positives are unsurprising, since these activities may involve modifying an executable file.

Although these rates are encouraging for such generic rules, even the three false positives observed for the RRWW rule may be too high for certain circumstances, but not necessarily. Therefore, aspects of an embodiment may provide solutions to this situation as well and are discussed below.

TABLE 4
False Positives Causes.

| | | | | Write- |
|---|---|---|---|---|
| Cause | RRWW | RWW | Update-Header | Anywhere |
| Updates | 0 | 0 | 0 | 73 |
| System Restores | 2 | 13 | 33 | 33 |
| Installations | 0 | 0 | 0 | 10 |
| Software | 1 | 2 | 2 | 2 |
| Development | | | | |

Program Updates. Typical Windows users frequently update programs so it is essential to handle updates and installations without any user disruption. Program updates recognized by the Write-Anywhere rule were the single largest source of our false positives in our data. These updates did not match the other rules, because they did not read and write to the same executable file. There were 73 false positives for the Write-Anywhere rule caused by updates in our data (of which 65 were for Windows updates). There were many program updates in the traces that did not generate false positives, even for the Write-Anywhere rule. Updates that create a new file and then perform a rename (overwriting the older version of the program) would not match any detection rules. Note, however, that a virus could infect files without detection by using the same strategy.

One solution is to change the way that updates are done, ideally by requiring cryptographic signatures. Signing updates has other benefits, regardless of the detector, since unsigned updates are inherently vulnerable [Bel06, See Anthony Bellissimo, John Burgess, and Kevin Fu. Secure Software Updates: Disappointments and New Challenges. USENIX Hot Topics in Security (HotSec), July 2006, of which is hereby incorporated by reference herein in its entirety.]. An aspect of an embodiment that enables secure updates would verify the signature on the update using the disk processors without trusting the host. Hence, the public key used to check the signature must be stored in a protected way on the disk and the signature check should be performed by the disk drive processor.

Another solution is to embed the program key in the original executable where an aspect of an embodiment involving infection rules would prevent the public key from being modified. When a program is updated, the signed update would arrive at the disk which would verify the signature, and allow the update without advancing the detection rule. This could be deployed with existing operating systems without any modification, but it would require cooperation from program vendors or trusted intermediary proxies. This proposal of using an embedded key is related to security functionality provided in some disk drives today, such as Seagate's DriveTrust [Sea06, See Drivetrust Technology: A Technical Overview. Seagate Whitepaper. http://www.seagate.com/docs/pdf/whitepaper/TP564_DriveTrust_Oct06.pdf., of which is hereby incorporated by reference herein in its entirety.].

System Restores. System restores allow a user to revert to a previous state on the machine [Mic01, See Microsoft. Use System Restore to Undo Changes if Problems Occur. August 2001. http://www.microsoft.com/windowsxp/using/helpandsupport/learnmore/systemrestore.ms px., of which is hereby incorporated by reference herein in its entirety.]. This is accomplished through restore points created at important system events (e.g., when an application is installed). One user in the test group had this feature turned on, and it caused the second largest bulk of the observed false positives (33 matched by the Update-Header and Write-Anywhere rule, as well as the only positives not related to software development caused by the RRWW and RWW rules). Windows system restore causes false positives when it is turned on, even if no restore is actually performed.

For legacy systems, the disk can record where the restoration data will be placed when the OS is installed. Then, the disk can follow the restoration data through the lifetime of the installation ensuring no writes take place to the restoration data. When a restore occurs, an aspect of an embodiment involving the disk processor can safely determine data integrity by checking the data written matches the saved restoration data for the corresponding block. In a complete redesign, the OS would not manage system restoration at all. Instead, an aspect of an embodiment involving the disk would create restoration points, saving restoration data in protected blocks that are not visible to the host OS. When a system restore is done, it would be conducted directly by the disk using the protected blocks.

Program Installation. Ten false positives occurred with the Write-Anywhere rule due to program installation in our traces. All of these were caused by a SanDisk USB for one of the users. This automatically installs software onto the local disk [San07b, See SanDisk U3. Frequently Asked Questions About U3. http://www.sandisk.com/Retail/Default.aspx?CatID=1450, of which is hereby incorporated by reference herein in its entirety.]. No other false positives due to program installation in our trace data were encountered, but in order to investigate program installers more thoroughly, traces of five programs using Microsoft's Installer were generated (MSI) [MSI07, See Microsoft Windows Installer. http://msdn2.microsoft.com/en-us/library/aa372866.aspx, of which is hereby incorporated by reference herein in its entirety.], and another three programs using the popular Nullsoft Scriptable Install System (NSIS) installer [NSI07, See Nullsoft Scriptable Install System (NSIS). http://nsis.sourceforge.net/Main_Page, of which is hereby incorporated by reference herein in its entirety.].

For these installation traces, false positives were registered by only the Write-Anywhere rule: two of the three NSIS installers and four of the five MSI installers. Anything that could be done to weaken the Write-Anywhere rule to exclude these behaviors might also present an opportunity for virus authors to circumvent the detector. Instead, these activities should be dealt with by changing the way programs are installed to avoid overwriting existing executables. Any overwrites needed to install a program should instead be done using the secure mechanisms described for program updates.

Software Development. Some false positives were observed from Visual Studio 2005 for all of the rules for two users in our user traces. The single false positive that matched the RRWW rule and the two false positives that matched the RWW rule were all caused by benchmarking using Visual Studio 2005. Some additional traces were generated to better understand false positives caused by software development by performing various activities using Microsoft Visual Studio 2005, LCC-Win32, and Borland's C++ compiler (version 5.5). In these traces, false positives were encountered for all the compilers with the Write Anywhere rule, but did not for any of the other rules.

Other Virus-Like Programs. Various other activities have the potential to exhibit virus-like behavior including anti-virus software and Digital Rights Management (DRM) applications. Although no false positives due to AV software in the test traces were encountered, some AV software is designed to exhibit virus-like behavior itself AV software may write into executables storing a checksum in the file header in order to speed up scanning [See Kas05, of which is hereby incorporated by reference herein in its entirety]. Ideally, the disk-level detector would be closely integrated with the host-level scanning software, so these updates could be done in a recognizable way, perhaps even by the disk processor itself. Another solution would be to modify the AV software to use an external database to store checksums making it unnecessary to write into executables [See Kas05, of which is hereby incorporated by reference herein in its entirety.]. Some DRM schemes attempt to limit executable file use by directly writing how many times the program has been executed into the file.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

We claim:

1. A computerized method for detecting malware by observing behavior of a computer system in actual program execution from outside of a host operating system.

2. The method of claim 1, wherein said observing of the behavior comprises:
intercepting requests that are destined for computer disk; and
inferring corresponding file system actions.

3. The method of claim 2, wherein said intercepting disk requests comprises viewing the read and write operations sent from the host to the disk.

4. The method of claim 3, wherein said inferring file system actions comprises analyzing said intercepted disk requests to identify malware behaviors.

5. The method if claim 4, wherein said analyzing comprises applying predetermined screening rules.

6. The method of claim 5, wherein said application of predetermined screening rules comprises at least one of the following:
rules for detecting infections of Windows executable files based on the known structure of executable files and the steps needed to successfully infect an executable file, rules for detecting suspicious modifications to core system files and other critical files, and rules recognizing behavior of known malicious programs based on their disk access patterns, or any combination thereof.

7. The method of claim 1, further comprising responding to said malware detection.

8. The method of claim 7, wherein said response comprises the halting of the intercepted disk request.

9. The method of claim 8, wherein said halting comprises disallowing writes that are determined to be malicious.

10. The method of claim 7, wherein said response comprises providing notification to host operating system, remote system, or a user, producing a log file, changing behavior of the disk, sending messages over the network, or any combination thereof.

11. The malware detection system of claim 1 wherein the computerized method is implemented on the said computer disk.

12. The method of claim 11 wherein said implementation is executed by a processor on said computer disk.

13. The malware detection system of claim 1 wherein the computerized method is implemented on a virtual machine outside of the operating system.

14. The malware detection system of claim 1 wherein the computerized method is implemented on both a virtual machine outside of the operating system and on the said computer disk.

15. The method of claim 1, wherein said malware comprises at least one of the following: Computer viruses, worms, Trojan horses, spyware, dishonest adware, and other malicious and unwanted software, or combinations thereof.

16. The method of claim 1, wherein said computer disk comprises any digital storage system such as a hard disk, USB disk, network disk, disk array controller, or storage appliance.

17. A computerized detection system for detecting malware, wherein said computerized detection system observes behavior of a host computer system in actual program execution from outside of a host operating system of the host computer system.

18. The computerized detection system of claim 17, wherein said observing of the behavior comprises:
intercepting requests that are destined for computer disk; and
inferring corresponding file system actions.

19. The computerized detection system of claim 18, wherein said intercepting disk requests comprises viewing the read and write operations sent from the host to the disk.

20. The computerized detection system of claim 19, wherein said inferring file system actions comprises analyzing said intercepted disk requests to identify malware behaviors.

21. The computerized detection system of claim 20, wherein said analyzing comprises: applying predetermined screening rules.

22. The computerized detection system of claim 21, wherein said application of predetermined screening rules comprises at least one of the following:
rules for detecting infections of Windows executable files based on the known structure of executable files and the steps needed to successfully infect an executable file, rules for detecting suspicious modifications to core system files and other critical files, and rules recognizing behavior of known malicious programs based on their disk access patterns, or any combination thereof.

23. The computerized detection system of claim 17, further comprising responding to said malware detection.

24. The computerized detection system of claim 23, wherein said response comprises: the halting of the intercepted disk request.

25. The computerized detection system of claim 24, wherein said halting comprises disallowing writes that are determined to be malicious.

26. The computerized detection system of claim 23, wherein said response comprises providing notification to host operating system, remote system, or a user, producing a log file, changing behavior of the disk, sending messages over the network, or any combination thereof.

27. The computerized detection system of claim 17, wherein said computerized system comprises a computer disk.

28. The computerized detection system of claim 27, wherein said computerized system comprises a processor on a computer disk.

29. The computerized detection system of claim 17 wherein the computerized detection system comprises a virtual machine outside of the operating system.

30. The computerized detection system of claim 17 wherein the computerized detection system comprises both a virtual machine outside of the host operating system and a computer disk.

31. The computerized detection system of claim 17, wherein said malware comprises at least one of the following: Computer viruses, worms, Trojan horses, spyware, dishonest adware, and other malicious and unwanted software, or combinations thereof.

32. The computerized detection system of claim 17, wherein said computer disk comprises any digital storage system such as a hard disk, USB disk, network disk, disk array controller, or storage appliance.

33. A computer program product comprising a computer useable medium having a computer program logic for enabling one processor to detect malware, said computer program logic comprising:
observing behavior of a computer system in actual program execution from outside of a host operating system.

34. The computer program product of claim 33, wherein said observing of the behavior comprises:
intercepting requests that are destined for computer disk; and
inferring corresponding file system actions.

35. The computer program product of claim 34, wherein said intercepting disk requests comprises viewing the read and write operations sent from the host to the disk.

36. The computer program product of claim 35, wherein said inferring file system actions comprises analyzing said intercepted disk requests to identify malware behaviors.

37. The computer program product code if claim 36, wherein said analyzing comprises applying predetermined screening rules.

38. The computer program product of claim 37, wherein said application of predetermined screening rules comprises at least one of the following:
rules for detecting infections of Windows executable files based on the known structure of executable files and the steps needed to successfully infect an executable file, rules for detecting suspicious modifications to core system files and other critical files, and rules recognizing behavior of known malicious programs based on their disk access patterns, or any combination thereof.

39. The computer program product of claim 33, further comprising responding to said malware detection.

40. The computer program product of claim 39, wherein said response comprises the halting of the intercepted disk request.

41. The computer program product of claim 40, wherein said halting comprises disallowing writes that are determined to be malicious.

42. The computer program product of claim 39, wherein said response comprises providing notification to host operating system, remote system, or a user, producing a log file, changing behavior of the disk, sending messages over the network, or any combination thereof.

43. The computer program product of claim 33 wherein the computer program product code utilizes the said computer disk.

44. The computer program product of claim 43 wherein said utilization involves execution by a processor on said computer disk.

45. The computer program product of claim 33 wherein the computer program product code utilizes a virtual machine outside of the operating system.

46. The computer program product of claim 33 wherein the computer program product code is utilized on both a virtual machine outside of the operating system and on the said computer disk.

47. The computer program product of claim 33, wherein said malware comprises at least one of the following: computer viruses, worms, trojan horses, spyware, dishonest adware, and other malicious and unwanted software, or combinations thereof.

48. The computer program product of claim 33, wherein said computer disk comprises any digital storage system such as a hard disk, USB disk, network disk, disk array controller, or storage appliance.

49. A computerized method for detecting malware by using a computer disk to accelerate malware signature scanning from outside of a host operating system.

50. The method of claim 49, wherein accelerated scanning procedures are implemented on the computer disk to filter said intercepted disk requests.

51. The method of claim 50, wherein said filtering comprises any type of algorithm that can be used in malware detection.

52. The method of claim 51, wherein said algorithm comprises an RE-tree application.

53. The method of claim 52, wherein said RE-trees comprise hierarchical tree-based data structures that provide efficient indexing for regular expressions.

54. A computerized detection system for detecting malware, wherein said computerized detection system using a computer disk to accelerate malware signature scanning from outside of a host operating system of the host computer system.

55. The computerized detection system of claim 54, wherein accelerated scanning procedures are implemented on the computer disk to filter said intercepted disk requests.

56. The computerized detection system of claim 55, wherein said filtering comprises any type of algorithm that can be used in malware detection.

57. The computerized detection system of claim 56, wherein said algorithm comprises an RE-tree application.

58. The computerized detection system of claim 57, wherein said RE-trees comprise hierarchical tree-based data structures that provide efficient indexing for regular expressions.

59. A computer program product Comprising a computer useable medium having a computer program logic for enabling one processor to detect malware, said computer program logic comprises:
using a computer disk to accelerate malware signature scanning from outside of a host operating system.

60. The computer program product of claim 59, wherein accelerated scanning procedures are implemented on the computer disk to filter said intercepted disk requests.

61. The computer program product of claim 60, wherein said filtering comprises any type of algorithm that can be used in malware detection.

62. The computer program product code of claim 61, wherein said algorithm comprises an RE-tree application.

63. The computer program product of claim 62, wherein said RE-trees comprise hierarchical tree-based data structures that provide efficient indexing for regular expressions.
